(19) United States
(12) Patent Application Publication
(10) Pub. No.: US 2009/0083188 A1
(43) Pub. Date: Mar. 26, 2009

(54) Secure Data Systems and Methods

(75) Inventor: Jack Saltiel, Lawrenceville, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CADILLAC JACK, INC., Duluth, GA (US)

(21) Appl. No.: 11/861,424

(22) Filed: Sep. 26, 2007

(51) Int. Cl. H04L 9/00

(52) U.S. Cl. 705/64; 705/50

(57) ABSTRACT

Various embodiments of secure data systems and methods are disclosed. One method embodiment, among others, comprises associating information corresponding to a first negotiable instrument with a data structure, and providing a checksum to the data structure to prevent unauthorized modification of the information.

### TECHNICAL FIELD

The present disclosure relates to computer systems, and more particularly, to computer systems involved with the storage of sensitive data.

### BACKGROUND

In systems which handle monetary transactions, such as casino gaming systems (or banking systems, etc.), unused cash, change, and/or winners are frequently returned to a player in a negotiable instrument such as a bar-coded ticket or a ticket with a magnetic strip, or credited in an account referenced by an account number on a negotiable instrument such as a plastic account card with a magnetic strip. These instruments can be used by the player on other devices and at other stations in the casino or establishment to buy more goods or play more games, simply by inserting the instrument into a reader.

Coupled with each instrument is a corresponding data structure (e.g., database record or set of records) in a central server. Such a database record includes information about the instrument, including the monetary value of the instrument, when it was issued, why it was issued, if it has been partially or completely redeemed, if it has been cancelled, among other information. In many instances, the database record of the instrument is where the proper monetary value of the instrument is stored, and thus constitutes financially sensitive information that should not be compromised (e.g., by an unauthorized user of the server).

If the information is changed, such as a change in the monetary value of the instrument, it is possible for the user to redeem the ticket for a value other than that for which it was originally issued. In this case, for example, a ticket originally issued with a corresponding value of $2.50 may now possibly be redeemed for $1,250.00, far in excess of the original value.

Many central servers are protected with various levels of security, including password protection for access to the system, and further password protection for access to the database. However, user passwords, at whatever security levels, can be compromised either by employees of the system operator or manufacturer or by so-called “social engineering” to gain access to a live database of financial data to change the value of said instruments.

### SUMMARY

Various embodiments of secure data systems and methods are disclosed. One method embodiment, among others, comprises associating information corresponding to a first negotiable instrument with a data structure, and providing a checksum to the data structure to prevent, detect, or prevent and detect unauthorized modification of the information.

Other systems, methods, features, and advantages of the present disclosure will be or become apparent to one with skill in the art upon examination of the following drawings and detailed description. It is intended that all such additional systems, methods, features, and advantages be included within this description, and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the disclosed systems and methods. Moreover, in the drawings, like reference numerals designate corresponding parts throughout the several views.

FIG. 1 is a block diagram of an exemplary environment in which embodiments of secure data systems and methods are implemented.

FIG. 2 is a schematic diagram that illustrates an embodiment of a secure data system in the exemplary environment shown in FIG. 1.

FIG. 3 is a flow diagram that illustrates an embodiment of a secure data method.

FIG. 4 is a flow diagram that illustrates another embodiment of a secure data method.

FIG. 5 is a flow diagram that illustrates another embodiment of a secure data method.

### DETAILED DESCRIPTION

Disclosed herein are various embodiments of secure data systems and methods (herein, such systems and methods also referred to collectively as secure data systems). In such secure data systems, security of financially sensitive records (e.g., monetary data) in a computer data structure (e.g., database) is created by using an embedded checksum, which insures that a record or records in the database which contain the checksum are not altered without leaving a trace that it has been changed. The embedded checksum also ensures that the data cannot be casually changed. For instance, in some embodiments, the data can only be correctly changed with a deliberate act and knowledge of the checksum algorithm. The trace of the change can alert an operator to possible fraudulent activity.

The present disclosure now will be described more fully hereinafter with reference to the accompanying drawings, in which some, but not all embodiments are shown. Indeed, the disclosed systems and methods may be embodied in many different forms and should not be construed as limited to the embodiments set forth herein. Rather, these embodiments are provided so that this disclosure will satisfy applicable legal requirements. For instance, though described below in the context of a computer gaming system environment, it should be appreciated that the embodiments described herein can be extended to other financial storage environments, such as for banking systems, and hence are also included within the scope of the disclosure.

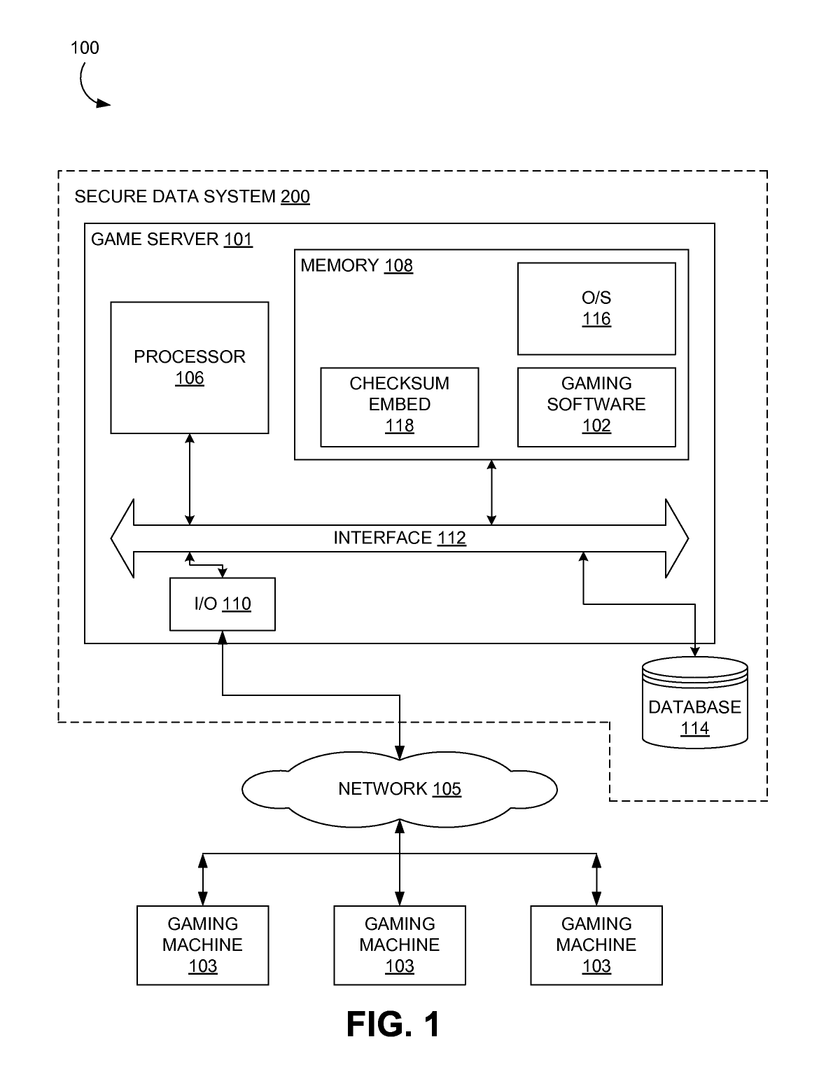

FIG. 1 is a block diagram of an exemplary environment in which embodiments of secure data systems can be implemented. In particular, the exemplary environment is comprised of a gaming system 100. The gaming system 100 includes such devices as a game server 101 networked to a plurality of individual gaming machines or devices 103 via a network 105 (e.g., a local area network (LAN) such as an Ethernet connection, a wide area network (WAN), among or other media). Each gaming machine 103 may be located locally or remotely with respect to one another.

In one embodiment, the game server 101 can implement gaming software 102 and checksum embedding software 118. The gaming software 102 includes one or more modules of code configured to provide well-known web-page or screen display generation and formatting mechanisms, as well as to provide random number generation, account creation (e.g., for magnetic cards or other non-monetary devices used at the gaming machines 103 in place of monetary devices (e.g., currency)), data base record creation, among other functionality for providing gaming system functionality in cooperation with the gaming machines 103. In some embodiments, random number generation and/or other functionality implemented by the gaming software 102 may be performed in hardware. The checksum embedding software 118 comprises one or more modules of code configured to interact with the gaming software 102, and provides (e.g., embeds) checksums in one or more financial-sensitive database records (records or in general, data structures) stored in a storage component or database 114. In some embodiments, the database records may be stored in another storage component such as memory 108 or other storage areas. Further, in some embodiments, though shown as separate modules, the functionality of the checksum embedding software 118 may be implemented via a sub-module of the gaming software 102, or in some embodiments, functionality of the gaming software 102 and the checksum embedding software 118 may be combined into a single module. In one embodiment, a secure data system 200 comprises the game server 101 and the database 114, though one having ordinary skill in the art should appreciate that in some embodiments, the secure data system 200 may comprise additional components (or fewer). For instance, in some embodiments, a secure data system may include the game server 101 with data records stored in memory 108. As another example, some embodiments of secure data systems may include the gaming machines (or other machines or devices, such as a money exchange machine) with functionality of the gaming software 102 and checksum embedding software 118 embedded therein. An alternate embodiment may include a database 114 as part of another game server or database server which may be remote from or in close proximity to the game server 101.

The gaming software 102 and the checksum embedding software 118 can be implemented in software, as an executable program, and can be executed by a special or general purpose digital computer, such as a personal computer (PC; IBM-compatible, Apple-compatible, or otherwise), workstation, minicomputer, or mainframe computer, or in an alternate embodiment may be implemented on a special purpose microprocessor chip. In some embodiments, at least some of the functionality of the gaming software and/or checksum embedding software 118 may be implemented in hardware.

Generally, in terms of hardware architecture, as shown in FIG. 1, the game server 101 includes a processor 106, memory 108, and one or more input and/or output (I/O) devices or peripherals 110 that are communicatively coupled via a local interface 112. The local interface 112 can be, for example, one or more buses or other wired or wireless connections. The local interface 112 may have additional elements (not shown) to enable communications, such as controllers, buffers (caches), drivers, repeaters, and receivers. Further, the local interface 112 may include address, control, and/or data connections to enable appropriate communications among the aforementioned components. The game server 101 can also communicate with the database 114 via the local interface 112. The local database 114 can be external to or integral to the game server 101.

The processor 106 is a hardware device capable of executing software, particularly that stored in memory 108. The processor 106 can be any custom made or commercially available processor, a central processing unit (CPU), an auxiliary processor among several processors associated with the game server 101, a semiconductor based microprocessor (in the form of a microchip or chip set), a macroprocessor, or generally any device for executing software instructions.

Memory 108 can include any one or combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory 108 may incorporate electronic, magnetic, optical, and/or other types of storage media. Note that memory 108 can have a distributed architecture, where various components are situated remote from one another, but can be accessed by the processor 106.

The software in memory 108 may include one or more separate programs, each of which comprises an ordered listing of executable instructions for implementing logical functions. In one example of the game server 101 of FIG. 1, the software in the memory 108 includes the checksum embedding software 118, gaming software 102, and a suitable operating system (O/S) 116. The operating system 116 essentially controls the execution of other computer programs, such as the checksum embedding software 118, and provides scheduling, input-output control, file and data management, memory management, and communication control and related services.

The checksum embedding software 118 and/or the gaming software 102 can each be a source program, executable program (object code), script, and/or any other entity comprising a set of instructions to be performed. When a source program, then the program may be translated via a compiler, assembler, interpreter, or the like, which may or may not be included within memory 108, so as to operate properly in connection with the operating system 116. Furthermore, the checksum embedding software 118 and/or gaming software 102 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, ASP, and Ada.

The I/O devices 110 may include input devices, such as a keyboard, mouse, scanner, microphone, etc., as well as interfaces to various devices (e.g., an interface to one or more progressive displays). Furthermore, the I/O devices 110 may also include output devices, such as a printer, display, etc. Finally, the I/O devices 110 may further include devices that communicate both inputs and outputs, for instance a modulator/demodulator (modem for accessing another device, system, or network), a radio frequency (RF) or other transceiver, a telephonic interface, a bridge, a router, etc.

When the game server 101 is in operation, the processor 106 is configured to execute software stored within memory 108, to communicate data to and from memory 108, and to generally control operations of the game server 101 pursuant to the software. The checksum embedding software 118, gaming software 102, and the operating system 116, in whole or in part, but typically the latter, are read by the processor 106, perhaps buffered within the processor 106, and then executed.

The checksum embedding software 118 and/or gaming software 102 can be stored on any computer readable medium for use by or in connection with any computer related system or method. In the context of this document, a computer readable medium is an electronic, magnetic, optical, or other physical device or mechanism that can contain or store a computer program for use by or in connection with a computer related system or method. The checksum embedding software 118 and/or gaming software 102 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

It is noted that the term “gaming machine” may refer to any device, activity or mode of play for gaming (e.g., gambling or redemption), amusement, competition, or other purposes. Additionally, “gaming machine” may refer to a “stand alone” player station or console in which case the outcome of game play is determined locally, or part of a server-based network of gaming machines in which case the outcome of game play is centrally determined. The gaming machine 103 generally includes a cabinet housing a primary display for displaying game events. The primary display may be a mechanical display such as used in traditional slot machines, or a video display such as a flat panel LCD as used in electronic games such as video bingo, video slots, video poker, video keno or video blackjack. The gaming machine 103 may also include the display of various information such as game rules or graphics designed to attract players to participate.

The gaming machine 103 also includes a series of electromechanical buttons positioned on the cabinet for use as a user interface for controlling game play such as selecting a bet amount, commencing play and cashing out. The specific arrangement and function of each of the electromechanical buttons is dependent upon the type of game being played on the gaming machine 103. For example, for a Blackjack game, the electromechanical buttons may include options for placing a bet, cashing out, hitting or standing, doubling down, purchasing insurance and/or splitting. Alternatively, in a poker game, the electromechanical buttons may include options for placing a bet, cashing out and/or designating which cards to keep and which to discard. In one embodiment, the primary display is a “touch screen” upon which icons corresponding to some or all of the electromechanical buttons appear. The user can activate the functions associated with the icons by simply touching the appropriate area of the primary display rather than depressing the electromechanical buttons.

The gaming machine 103 also includes a wager input interface, such as a bill acceptor into which a player inserts paper currency and receives credit on the gaming machine 103 for the amount deposited. In alternate embodiments, the wager input interface can be a ticket reader, a magnetic card reader, or similar mechanisms, into which the player places a ticket or magnetic card (e.g., generally speaking, a negotiable instrument, which includes cards or other devices that can be redeemed for cash, services, credit, or other consideration) encoded with a monetary value purchased from a cashier's station or vending machine.

A play session of the individual gaming machines 103 commences based on the choice of a player entered at the gaming machine 103. One exemplary manner of play is described below. The player places a wager by inputting currency or a ticket or magnetic card bearing game credits or the account number relative to a player's credit balance which can be found on the game server 101 into wager input interface of a primary gaming machine 103. In one embodiment, the gaming machine 103 indicates the amount of money or credit available for the player to bet during play. The player then proceeds to indicate the amount to be wagered on a particular play of the game, up to the lesser of the available game credits or the maximum allowable bet on the gaming machine 103. The player starts play of the game by selecting the appropriate choice among the electromechanical buttons. After the placing of a wager and commencing play of the primary gaming machine 103, the player interacts with the game. For example, if the game being played on the gaming machine 103 is blackjack, the player is dealt cards and subsequently makes decisions whether to stand, hit, double down, split or purchase insurance. Alternatively, if the game is poker, the player is dealt cards and makes decisions to try to achieve the best hand. Play of the game continues in typical fashion. A winning outcome results in the player receiving additional game credits. Conversely, a losing outcome results in the player's wager being forfeited.

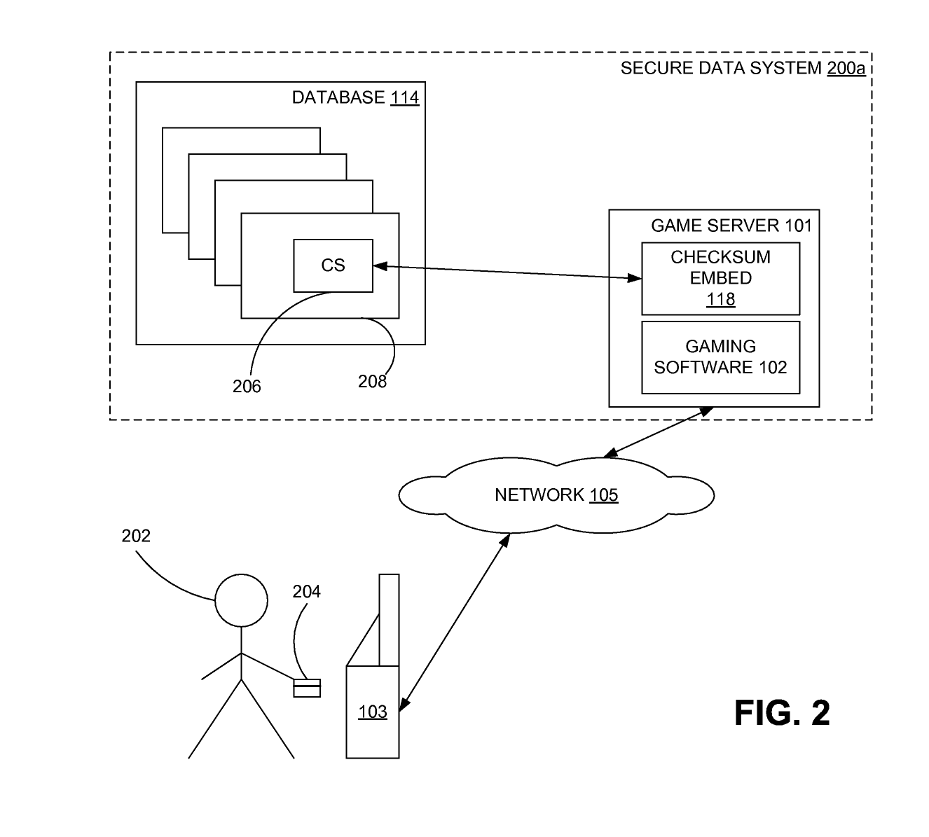

FIG. 2 is a block diagram that illustrates one embodiment of a secure data system 200a. The secure data system 200a comprises the game server 101 and the database 114 coupled to (and integral to in some embodiments) the game server 101. The game server 101, as explained above, includes the checksum embedding software 118 and gaming software 102, as well as other components described above in association with FIG. 1 and omitted here for brevity. In one exemplary implementation shown in FIG. 2, a player 202 submits money (e.g., currency) or credit card to the gaming machine 103, and in return, the game machine 103 returns a magnetic card 204 (e.g., a negotiable instrument) of a corresponding defined monetary value. In some embodiments, a separate machine may be used to exchange the money or credit card with a magnetic card (or other type of instrument). In one embodiment, responsive to receiving the money or credit card from the player 202, the gaming machine 103 requests an account from the game server 101. The game server 101 creates a unique identifier or account number (e.g., via random number generation functionality in the gaming software 102) and corresponding database record 208 for storage in the database 114. The database record 208 is populated with the financial information of the player 202. In one embodiment, the financial information may comprise a determined monetary value (e.g., determined by the gaming machine 103 based on the defined monetary value received at the gaming machine 103), wherein the determined monetary value is provided in the request (or in a separate transmission but associated with the request) from the gaming machine 103 to the game server 101. That is, in some circumstances, the defined monetary value may be different (though not necessarily so) than the determined monetary value based on a transaction fee, existing balance, etc. In some embodiments, the defined monetary value corresponding to the card or currency inserted by the user may be included with the request, and the game server 101 calculates the determined monetary value based on the defined monetary value. The checksum embedding software 118 also is involved in this account creation process, and in particular, embeds a checksum 206 into the newly created data record 208, and then forwards the data record 208 to the database 114. As the creation of checksums are known to those having ordinary skill in the art, the discussion of the same is omitted here for brevity. The game server 101 returns the randomly generated account number to the gaming machine 103, which marks the magnetic card 204 with the newly created account number and remits the magnetic card 204 to the player 202.

In some embodiments, each magnetic card 204 that is to be disbursed to a player 202 may have a predetermined account number (and corresponding data record) that is dormant until activated by the impending disbursement. In such embodiments, the activation results in an update by the gaming software 102 of the new financial information for the soon-to-be disbursed magnetic card, and the implementation by the checksum embedding software 118 to embed a checksum 206 into the activated data record. In some embodiments, the magnetic card is disbursed immediately after the player submits currency (or a credit card) into the gaming machine 103. In some embodiments, the magnetic card is disbursed upon receiving a signal or otherwise notice (e.g., notification) from the game server 101 that account number activation and checksum processing are complete.

Note that in some embodiments, some or all of the processing prior to storage of a database record in the database 114 can be performed at the gaming machine 103, and in some embodiments, at a machine for currency exchange that is separate from the gaming machine 103. Further, updates in the monetary value of the magnetic card 204 (e.g., through use at a device such as a gaming machine 103) result in a corresponding update by the gaming software 102 and the checksum embedding software 118 to the data base record 208 and checksum 206.

As explained above, the checksum 206 is used to ensure authentic data for each corresponding data record 208. That is, to secure financial data which can be changed to inure to the benefit of a user through unauthorized access, the embedded checksum is used by an operator of the gaming system 100 to ensure that sensitive data has not been changed. The checksum 206 that is created when the record in the data base is first created or populated is created by taking all of the sensitive data in the particular record and computing the checksum 206 based on this data. The so-called sensitive data that is used can be some or all of the data in the record. For example, there may be a need to allow certain parts of the record to be in the checksum 206, and thus protected, and other pieces of data to be unprotected. It is important that the monetary data is protected.

The checksum algorithm executed by the checksum embedding software 118 can be one of a number of widely available algorithms, such as MD5, SHAL, HMAC-SHA-1 or others. A custom modification of a standard algorithm may afford an additional level of protection in that off-the-shelf software is not available for someone to use to tamper with the database. In general, a checksum of the sensitive data is made by using one of these algorithms and in one embodiment, is stored in the database record 208 along side the data. Every time the data is accessed by a piece of software in the game server 101, a new checksum is computed to verify that the existing data and checksum match. If there is not a match, then such a circumstance indicates that a piece of sensitive data has been tampered with by an outside operator. An authorized operator may be alerted to such a tampering event by various known mechanisms, including email notification, or prompt or pop-up window alerts.

Tampering with the data to create a new checksum is not a trivial process that can be performed manually by someone tampering with the system as a result of this checksum process.

In an alternate embodiment, the checksum algorithm can be performed on the sensitive data and additional data that is specific to each installation. This additional data can include, among other data, the serial number of the server computer, the date and time of the software installation on the server or other data unique to the installation. When this additional data is used in conjunction with the sensitive data to compute the checksum, then an additional barrier is created that makes it impossible or virtually impossible for someone to copy data with a checksum from one system to another.

In some embodiments, the secure data system 200 can use the checksum process to ensure authentication of data corresponding to multiple data records. For instance, multiple data records may be interlocking (e.g., via a shared identifier), and when one data record is modified, the checksum operation (executed by the checksum software 118 and processor 106) performed on a previous data record can detect modifications in subsequent data records.

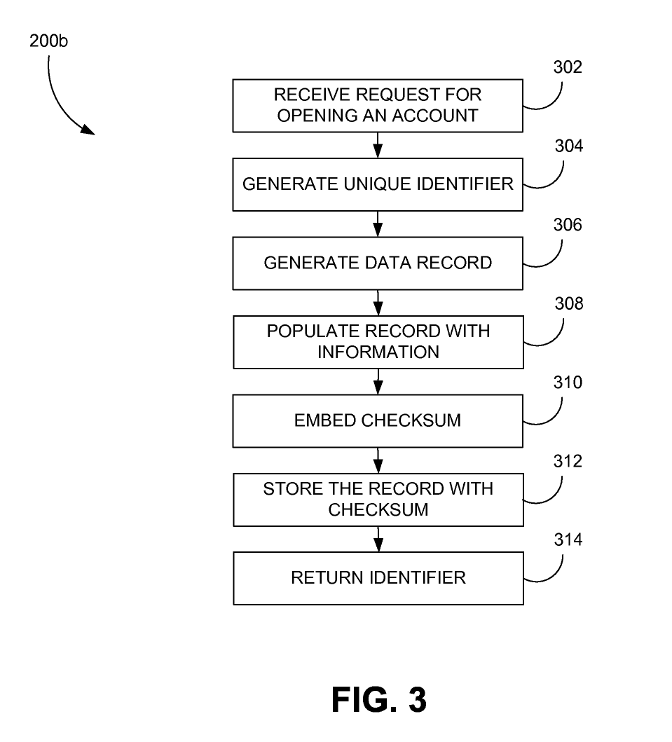

Having described various embodiments of the gaming system 100, one should appreciate in the context of the disclosure that one secure data method embodiment, referred to also as secure data method 200b and illustrated in FIG. 3, comprises receiving a request for opening an account (e.g., the game server 101 receiving a request from the game machine 103) (302), generating a unique identifier (304), generating a data record corresponding to the account (306), populating the record with information (308), embedding a checksum (310), storing the record with checksum (312), and returning the identifier to the requesting device (e.g., game machine 103). The gaming machine 103 then marks (e.g., optically, electronically, magnetically, mechanically, etc.) a negotiable instrument stored in the game machine 103 and disburses the same to the user of the game machine that prompted the request.

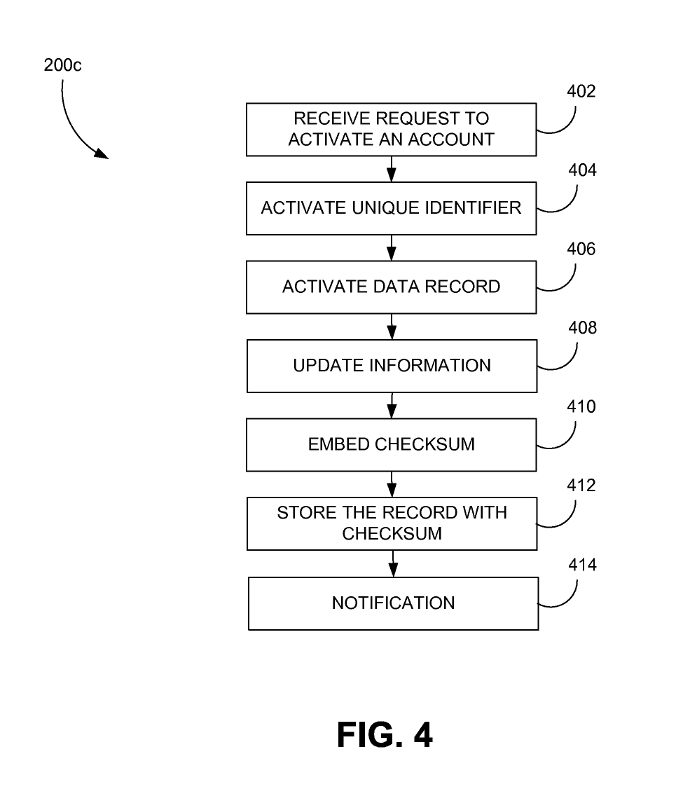

Another method embodiment, referred to also as secure data method 200c and shown in FIG. 4, comprises receiving a request to activate an account (402), activating a unique identifier (404) and corresponding data record (406), updating the information (e.g., recalculating the monetary value, updating the status of the account as active, updating time and date entries, etc.) (408), embedding a checksum (410), storing the record with the checksum (412), and optionally, notifying the requesting device (e.g., gaming machine) that processing (e.g., account activation, checksum processing, etc.) is complete (414). As set forth above, the gaming machine 103 may in some embodiments disburse a previously dormant (now activated) negotiable instrument immediately upon receipt of currency or a negotiable instrument from a user that prompts activation of the account, or in response to the notification.

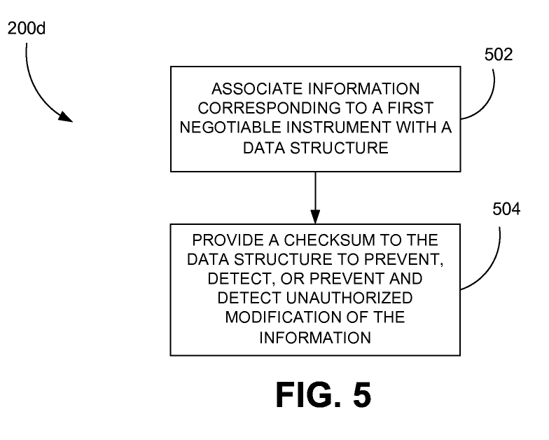

Another method embodiment, referred to as a secure data method 200d and shown in FIG. 5, comprises associating information corresponding to a first negotiable instrument with a data structure (502) and providing a checksum to the data structure to prevent, detect, or prevent and detect unauthorized modification of the information (504). In one embodiment, the first negotiable instrument may be a card that has an identifier that is dormant and activated (along with a corresponding record) at the game server 101 by a request from the gaming machine 103 in response to the insertion of currency or a second negotiable instrument into the gaming machine 103 by a user. The card is disbursed upon determining the monetary value of the card. In some embodiments, the dormant identifier may be saved at the game server 101 (or database 114) and activated, whereas the record is first initiated in response to the request. In some embodiments, a card is marked with a new identifier in response to the process set in motion by the insertion of currency or a negotiable instrument.

The flow diagrams of FIGS. 3-5 show the architecture, functionality, and operation of a possible implementation of various embodiments of secure data systems 200b, 200c, and 200d. In this regard, each block represents a module, segment, or portion of code, which comprises one or more executable instructions for implementing the specified logical function(s). It should also be noted that in some alternative implementations, the functions noted in the blocks may occur out of the order noted in FIGS. 3-5. For example, two blocks shown in succession in FIGS. 3-5 may in fact be executed substantially concurrently or the blocks may sometimes be executed in the reverse order, depending upon the functionality involved, as will be further clarified hereinbelow.

Additionally, though described in the context of the architecture shown in FIGS. 1 and 2, one having ordinary skill in the art should appreciate, in the context of the present disclosure, that the methods 200b-200d are not limited to implementation by the gaming system 100 shown in FIG. 1, but may be implemented in other system or apparatus embodiments and/or other environments as well. Additionally, in some embodiments, the checksum maybe otherwise associated with the data structure according to various mechanisms.

It should be emphasized that the above-described embodiments are merely possible examples of implementations, merely set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

At least the following is claimed:

1. A method, comprising:
associating information corresponding to a first negotiable instrument with a data structure; and
providing a checksum to the data structure to prevent, detect, or prevent and detect unauthorized modification of the information.

2. The method of claim 1, wherein the associating and the providing are implemented at a local device, and further comprising:
receiving currency or a second negotiable instrument from a user, the currency or the second negotiable instrument having a defined monetary value;
determining a value for the first negotiable instrument based on the defined monetary value; and
disbursing the first negotiable instrument to the user, the first negotiable instrument having the determined monetary value, the information comprising the determined monetary value.

3. The method of claim 2, wherein associating further comprises:
generating a unique identifier and the data structure corresponding to the unique identifier; and
populating the data structure with the unique identifier and the determined monetary value, the information further comprising the unique identifier.

4. The method of claim 3, further comprising marking the first negotiable instrument with the unique identifier.

5. The method of claim 1, wherein the associating and the providing are implemented at a remote device, and further comprising:
receiving a request from a local device to generate an account responsive to the device receiving currency or a second negotiable instrument, the currency or the second negotiable instrument having a defined monetary value.

6. The method of claim 5, wherein the associating further comprises:
generating a unique identifier and the data structure corresponding to the unique identifier responsive to the request; and
populating the data structure with the unique identifier and a determined monetary value corresponding to the first negotiable instrument, the determined monetary value based on the defined monetary value.

7. The method of claim 6, wherein the request comprises the determined monetary value as calculated at the local device based on the defined monetary value.

8. The method of claim 6, wherein the request comprises the defined monetary value.

9. The method of claim 8, further comprising calculating the determined monetary value based on the defined monetary value.

10. The method of claim 6, further comprising sending the unique identifier to the local device.

11. The method of claim 6, wherein the information comprises the determined monetary value, the unique identifier, or a combination of both.

12. The method of claim 1, wherein the associating and the providing are implemented at a remote device, and further comprising:
receiving a request from a local device to activate a dormant account responsive to the device receiving currency or a second negotiable instrument, the currency or the second negotiable instrument having a defined monetary value.

13. The method of claim 12, wherein the associating further comprises:
activating a unique identifier and the data structure corresponding to the unique identifier responsive to the request; and
updating the data structure with a determined monetary value corresponding to the first negotiable instrument, the determined monetary value based on the defined monetary value.

14. The method of claim 13, wherein the request comprises the determined monetary value as calculated at the local device based on the defined monetary value.

15. The method of claim 13, wherein the request comprises the defined monetary value.

16. The method of claim 15, further comprising calculating the determined monetary value based on the defined monetary value.

17. The method of claim 13, further comprising notifying the local device of account activation, checksum processing completion, or a combination of both.

18. The method of claim 13, wherein the information comprises the determined monetary value, the unique identifier, or a combination of both.

19. The method of claim 1, further comprising updating the data structure responsive to use of the first negotiable instrument, wherein the use corresponds to a change in the information, wherein the updating comprises revising the checksum.

20. A system, comprising:
a processor configured to embed a checksum into a data structure to detect unauthorized modification of information stored in the data structure, the data structure comprising information corresponding to a first negotiable instrument.

21. The system of claim 20, wherein the processor is configured to embed the checksum in the information, the information comprising one or more of a unique identifier corresponding to the first negotiable instrument, a determined monetary value corresponding to the first negotiable instrument, and additional data.

22. The system of claim 20, wherein the processor is further configured to determine whether there has been tampering of the information, the determination based on an evaluation of the checksum after each access of the information.

23. The system of claim 20, further comprising a storage component, wherein the processor is further configured to store the data structure in the storage component.

24. A computer readable medium having a program stored therein, the program comprising code executed by a computing device to perform the following steps:
receiving a request to open an account responsive to a user requesting monetary credit, the monetary credit embodied in a negotiable instrument to be disbursed to the user;
generating a unique identifier and corresponding data record, the unique identifier corresponding to the negotiable instrument;
populating the data record with information corresponding to the negotiable instrument, the information comprising at least a value corresponding to the monetary credit; and
embedding a checksum into the information to prevent and detect unauthorized modification of the information.
